(19) United States
(12) Patent Application Publication
(10) Pub. No.: US 2022/0202041 A1
(43) Pub. Date: Jun. 30, 2022

(54) REWORK PROCESS FOR PLANT-BASED FOOD PRODUCTION

(71) Applicant: The Livekindly Company Switzerland GmbH, Pfäffikon (CH)

(72) Inventor: Achim Knoch, Minden (DE)

(21) Appl. No.: 17/543,402

(22) Filed: Dec. 6, 2021

Related U.S. Application Data
(60) Provisional application No. 63/132,323, filed on Dec. 30, 2020.
(60) Provisional application No. 63/180,921, filed on Apr. 28, 2021.

(51) Int. Cl. A23J 3/26; A23J 3/22; A23P 30/20

(52) U.S. Cl. CPC A23J 3/26; A23P 30/20; A23J 3/227

(57) ABSTRACT

The present disclosure relates to a rework process wherein raw material for making plant-based food products is reprocessed at the early stages of food production, thereby minimizing waste and improving food production. The rework process comprises reprocessing output material from an extruder, comprising cutting and kneading the output and pumping it back into the extruder via a pressure generated by sausage filler for another round of processing via a high moisture extrusion process.

### PRIORITY CLAIM AND CROSS-REFERENCE TO RELATED APPLICATIONS

This application claims priority of the following provisional patent applications:
1. Prov. App. Ser. No. 63/132,323 titled “Process and Composition for Plant-Based Food Products,” by Achim Knoch filed on Dec. 30, 2020; and
2. Prov. App. Ser. No. 63/180,921 titled “Rework Process for Plant-Based Food Production,” by Achim Knoch filed on Apr. 28, 2021.
   All of the above-listed US provisional patent applications are incorporated by reference herein in its entirety, including all references and appendices cited therein, for all purposes.

This application is also related to U.S. application Ser. No. 17/543,358, filed on Dec. 6, 2021, entitled “Process and Composition for Plant-Based Food Products,” by Achim Knoch (Atty. Docket Number 9702U5), which is hereby incorporated by reference herein in its entirety, including all references and appendices cited therein, for all purposes.

### FIELD OF THE INVENTION

The invention generally relates to a rework process for plant-based food production, such as vegan food production for reducing waste production and improving food productivity.

### BACKGROUND

In modern society, people are adopting various eating lifestyles, one of them eating vegan food. The food market also sees several changes, including an influx of food varieties catering to individual needs, such as providing various vegan food products.

Plant-based food products have witnessed several advancements, including technological advancement. However, many such advances suffer from massive waste production and reduced productivity because the food product is not as per the desired quality, texture, or color. As a result, companies suffer from huge losses discouraging commercial production companies to make further investments or continuing in the business of plant-based food production.

The present disclosure addresses these problems and provides a process for reducing wastage and increasing food production without compromising on the quality of the food.

### SUMMARY

In summary, provided herein is a rework process of reprocessing raw material for making a food product in the early stages of food production, wherein the rework process reduces waste production and improves food productivity yielding high-quality plant-based food products. More specifically, provided herein is a process of reprocessing raw material for making vegan food products in the early stages of food production, wherein the rework process reduces waste production and improves vegan food productivity.

In various embodiments, provided herein is a rework process of plant-based food production, comprising: providing a batch of material, comprising at least a plant protein and at least an aqueous phase, introduced simultaneously, within a mixer such that the mixer blends the plant protein and aqueous phase, preferably water to form a dough; feeding the dough into an extruder via a sausage filler, wherein the dough is provided through the feeding side of the extruder with the help of pressure generated by the use of sausage filler; subjecting the dough to an initial high moisture extrusion (HME) process within the extruder, wherein the dough undergoes HME process and discharges from the extruder as a HME material; and passing the HME material through a control system, wherein the control system assesses the quality of the HME material against a pre-defined parameter within the control system. In many embodiments, the pre-defined parameter may be a defined color of the HME material, a defined texture of the HME material, a defined sponginess of the HME material, such that if the HME material is not as per the color, texture, consistency, sponginess, or other such defined parameters, the HME material will fail in the control system and routed to reprocessing whereas if the HME material is according to the color, texture or other pre-defined parameters, the HME material will move further to the next step in the food production, such as cutting. The HME material is processed dough, wherein the dough fed into the extruder undergoes HME process and is processed for preparing plant-based food product.

In various embodiments, the HME material is either subjected to further processing for food production if the HME material is as per the pre-defined parameter, such as the HME material is subjected to cutting, additional mixing, freezing, and packaging for commercial use, or the HME material is subjected to reprocessing, wherein the HME material is subjected to cutting, kneading, mixing followed by pumping the HME material back into the extruder for another round of HME process before the HME material can move further in the food production. By assessing the quality of food in early production stages, the disclosed rework process improves food productivity, wherein the material is subjected to reprocessing in the early stages of food production instead of using the material for the final food product and then rejecting the final food product because the final food product is not of acceptable standards.

In various embodiments, reprocessing the HME material from the extruder saves both the time and material as the HME material from the extruder is not passed along the production line but is assessed for quality in the early stages of production, such that if the HME material is not as per the acceptable standard, the material can be looped back into the extruder instead of moving further along for the food production, thus saving the material from going waste at final stages and also save time as the manufacturer can produce more food in the same amount of time and from the same amount of raw material.

In various other embodiments, the reprocessing comprises: finely cutting the HME material as very small chunks or tiny chunks; kneading the finely cut HME material; pumping the HME material through sausage filler into the extruder, wherein the HME material is subjected to another round of HME process.

In many embodiments, the process further comprises: optionally mixing at least an ingredient in a cooking tumbler to add flavor, texture, taste, or color to the HME material, passing the chunks through a cooling die, heating the chunks, wherein the chunks may be heated at a temperature of at least 80° C.; freezing the chunks using IQF-freezing or another known freezing method for preservation and transportation of the HME material; and packaging the chunks in the presence of protective gas, wherein the chunks may be a component for producing a plant-based food product or directly as a plant-based food product.

In many embodiments, the process further comprises: optionally mixing at least an ingredient in a cooking tumbler to add flavor, texture, taste, or color to the HME material, passing the chunks through a cooling die; freezing the chunks using IQF-freezing or another known freezing method for preservation and transportation of the material; and packaging the chunks in the presence of protective gas, wherein the chunks may be a component for producing a plant-based food product or directly as a plant-based food product.

In various embodiments, the rework process as disclosed herein reprocesses the raw material, such as HME material or an output material from the extruder back into the extruder through the feeding side of the extruder with the help of pressure generated via the sausage filler and subject the HME material to another round the HME process.

In various embodiments, the plant protein and water are mixed in a ratio of 1:1.

In various other embodiments, the rework process is a part of a plant-based food production line and thus helps reduce waste production and improve productivity.

In many embodiments, the control system is a step in a food production cycle, wherein the control system helps maintain the total output or yield of food produced per production line as constant and proportional to the raw material.

In various embodiments, the control system comprises a flow meter, wherein the flow meter measures the amount of output material from the extruder, such that if the output material such as HME material, reprocessed HME material or processed dough from the extruder reaches a specific pre-set limit, a message is communicated to a main system of the food production system to proportionally adjust the next batch of raw material to maintain the total output of the food produced per production line as constant.

In many embodiments, the control system is connected to the main system of a food production line, such that the control system is in constant communication with the main system during the active food production cycle so as to keep the output from the extruder constant and reduce waste production.

In many embodiments, plant protein may be a soy protein, a pea protein, a wheat protein, milk protein, a protein powder blend, a vegetable protein, or other plant-sourced protein comprising a high fiber content or a low fiber content. In many other embodiments, the plant-based food product is a vegan or non-meat food product.

Other systems, methods, features and advantages of the invention will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The accompanying drawings, where like reference numerals refer to steps of the process and embodiments, together with the detailed description below, are incorporated in and form part of the specification and serve to illustrate further embodiments of concepts that include the claimed disclosure and explain various principles and advantages of those embodiments.

The process and composition disclosed herein have been represented where appropriate by conventional symbols in the flowcharts, photographs, or drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a flow chart showing an example rework process for plant-based food production.

FIG. 2 illustrates a flow chart showing a rework process for plant-based food production within the batch mixing process.

The exemplary embodiments described and illustrated herein should be applicable to all plant-based food products (should be specified to plant-based HME products).

### DETAILED DESCRIPTION

While the presently disclosed process and composition are susceptible of embodiment in many different forms, there is shown in the figures and will herein be described in detail several specific embodiments with the understanding that the present disclosure is to be considered as an exemplification of the principles of the present technology and is not intended to limit the technology to the embodiments illustrated.

In summary, provided herein is a rework process for higher yield of plant-based food products, such as vegan food products, wherein the material for making the food product may be reprocessed at earlier stages of production, minimizing waste and improving productivity. More particularly, provided herein is a process for reprocessing the material for making a vegan food product to achieve a defined structure and color.

The currently available high moisture extrusion (HME) lines for commercial plant-based food production have the potential of high throughput output, requiring a large quantity of starting material. However, companies often suffer from quality issues, color issues, waste, and thus lower production volume. A significant reason for the production of waste is that the final food product is not of acceptable texture, color, or quality or the quality of the extruder product is not of acceptable standards. The present disclosure addresses these problems and will help reduce such waste production by rework or backflow process. The process provided herein reprocesses the material from an extruder and pumps it back into the feeding system for another round of processing within the extruder. The backflow process or rework process is a part of the production chain and thus reprocesses the material or raw material in the early stages of production, e.g. the warm-up phase, which saves both time and material. The backflow or the rework system, as disclosed, also helps assess the quality and texture of the material in the early stages of food production.

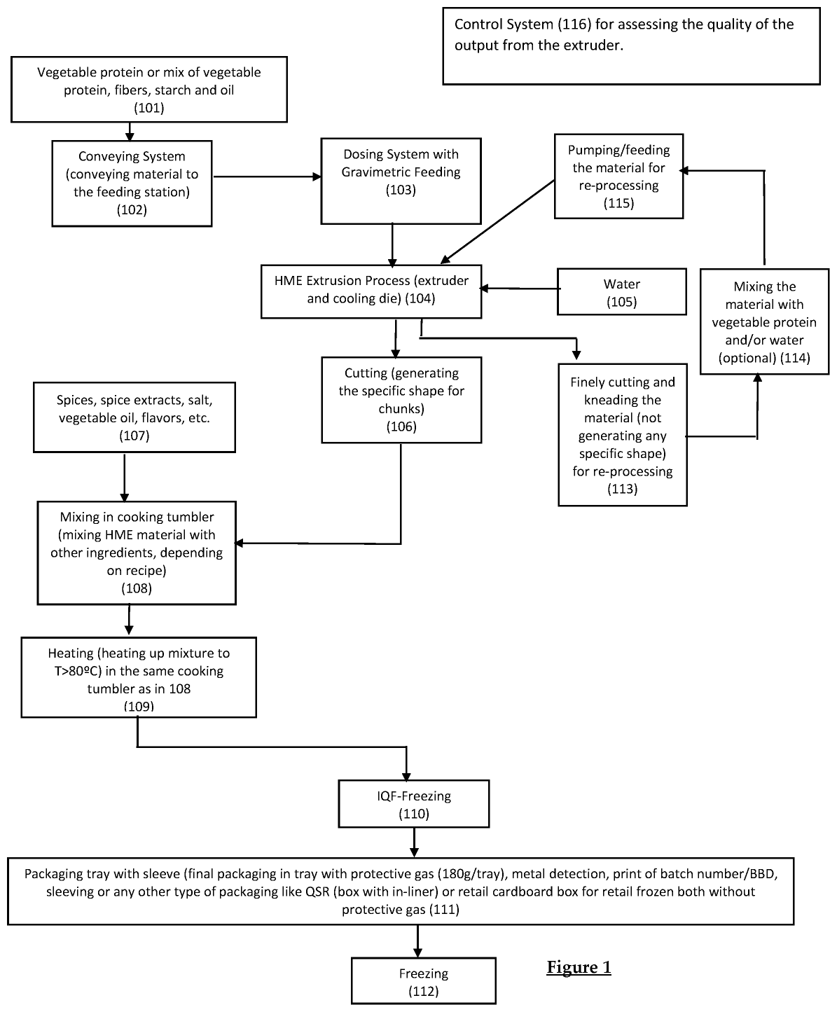

FIG. 1 depicts a flow chart showing an example backflow process or rework process of making plant-based food products. As shown in FIG. 1, vegetable proteins (101) or a mix of vegetable protein, fibers, starch, and oil is introduced into a conveying system (102), wherein the conveying system conveys material such as vegetable protein (101) into a feeding station with, e.g. gravimeter feeding (103). The material then passes through an HME process (104), wherein the material passes through an extruder and a cooling die. Water (105) is further added to the extruder directly. The protein-water mix undergoes an HME extrusion process to form the extruder product. The extruder product is assessed for its color, quality, texture, and other parameters via a quality control process. Based on the assessment via quality control parameters, extruder product will either be subjected to cutting (106), generating specific shapes such as chunks and processing such chunks further in the production line or reprocessing the extruder product (103-115) such as finely cutting and kneading the extruder product (113), optionally mixing more vegetable protein or water into the extruder product (114), and pumping the material for reprocessing directly into the extruder (115) for another round of HME extrusion process (104).

The disclosed backflow process further comprises a control system (116).

If the extruder product is acceptable, the extruder product will be cut into specific shapes, such as small chunks (106). The chunks may be mixed with other ingredients (107) within a cooking tumbler (108) to add flavors to the finished product. The choice of ingredients may include, but is not limited to, spices, spice extracts, salt, vegetable oil, or other such flavors, depending on the recipe of choice. The spice-mixed chunks or spice-mixed material is further subjected to heating (109) at more than 80° C. temperature within the cooking tumbler. Following heating (109), the spice-mixed mixture or food product is introduced to IQF-freezing (110). The frozen material is then packaged in, e.g. trays with sleeves (111) and re-freeze (112).

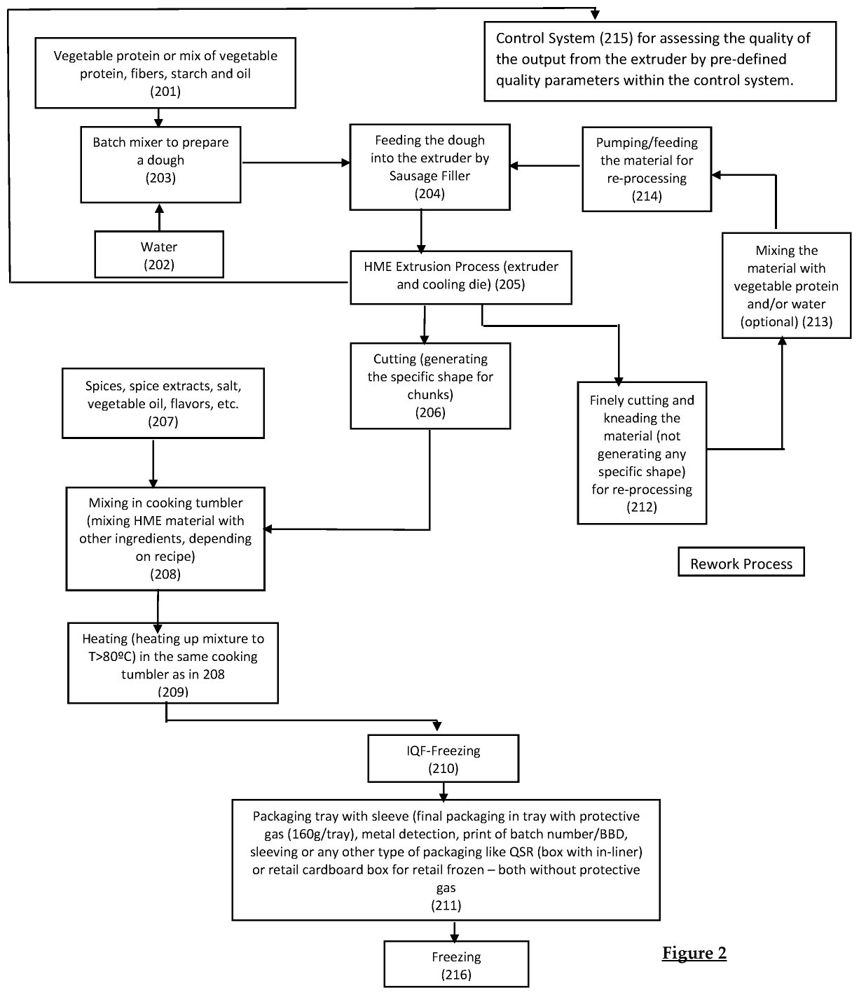

FIG. 2 illustrates a flow chart showing the disclosed process as part of plant-based food production. As shown in FIG. 2, vegetable protein or plant protein (201), such as plant-sourced protein or protein extracted from a plant and an aqueous phase, preferably water (202), are introduced simultaneously in batches into a mixer (203) to prepare a dough. The plant protein may be soy protein, pea protein, wheat protein, milk protein, plant-based protein, protein extracted or sourced from a plant, protein powder blends, protein blends or protein mixtures or a mix of vegetable protein, fibers, starch, and oil. The plant protein and water are mixed simultaneously in a batch mixer (203), forming a dry and crumbly dough with air bubbles. The protein and water may be mixed in a ratio of 1:1, 1:2 (one-part protein and two-parts water), 1:3 (one-part protein and three-parts water), 2:1 (two-parts protein and one-part water), 2:2 (two-parts protein and two-parts water), 3:1 (three-parts protein and one-part water), 1:4 (one-part protein and four-parts water), or another different ratio resulting in a dry and crumbly dough with air in it.

The dough prepared by the batch mixer method is fed into an extruder via a sausage filler (204). Feeding the dough into the extruder via a sausage filler provides many advantages, such as the system being a closed system; thus, fine distributed air in the dough cannot go out of the extruder towards the feeding side. Whereas feeding protein in the form of a powder into the extruder, as shown in the standard process in FIG. 1, adds an uncontrolled amount of additional air into the extruder from the powder causing issues during the HME process. Such issues are not present in the disclosed process as the dough is fed into the extruder instead of protein powder through the sausage filler creating an airtight system for the HME process. Owing to the use of a sausage filler to feed the dough into an extruder, the air within the dough does not leave the system and is in fact homogeneously distributed within the dough as very fine air bubbles. Although the air bubbles are not visible to the naked eye, the texture, sponginess, smoothness, density, and color of the finished food product appears very close to a meat food product, showing the effect of homogeneous distribution of air bubbles within the dough due to the batch mixing process as disclosed herein. Further, the structure of the food product remains stable even after cooking because the continuous phase, in this case, the HME texturized vegetable protein, is firm and will not collapse in a cooking step.

FIG. 2 further shows that after feeding the dough into an extruder using a sausage filler, the dough undergoes an HME extrusion process (205) wherein the material passes through an extruder and a cooling die, forming a HME material.

The HME material then passes through a control system (215), wherein if the HME material is as per the parameters pre-set or pre-defined within the control system, such as color, texture, sponginess, consistency, presence of lumps or not, bubbles are evenly distributed or not, the HME material moves to a next step in food production, such as subjected the HME material further to a cutting process (206) and generating chunks or if the HME material is not as per the parameters pre-set within the control system, the HME material from the extruder is routed back into the extruder for reprocessing (212-214).

For reprocessing, the HME material, after undergoing the HME process (205) and passing through the control system, is precut, then fine cut into any shape via a continuous cutter or other such equipment, followed by shearing via a colloid mill or other such equipment (212) to form a reprocessed HME material. The fine cutting and kneading prepare the reprocessed HME material for another round of processing under HME or reprocessing under HME.

The reprocessed HME material further may be mixed with vegetable protein such as soy protein and/or water (213). This step is optional. The mixing of additional vegetable protein may help in improving the food color and texture. The mixing will depend on the quality and consistency of the HME material from the extruder, such as the HME material being very dry, powdery, or watery. The reprocessed HME material may then be pumped/fed into the extruder via sausage filler for reprocessing (214). The reprocessed HME material is subjected to another round of the HME process (205). The sausage filler generates pressure between the sausage filler and the extruder, which helps easily and quickly feed the finely cut and kneaded HME material back into the extruder.

The disclosed process is a part of the food production wherein the process helps reduce wastage during food production and improves the overall yield. The control system helps maintain the total throughput yield from the extruder as constant, such as if the material for re-processing is added through 204, the feeding of material from 203 is proportionally reduced to maintain the overall yield from the extruder constant.

For the disclosed process, the HME material or output material from the extruder passes through a control system (215), wherein the control system manages the total throughput or output from the extruder, such that if the reprocessed material or HME material is pumped back into the extruder for another round of HME, the dough from the mixer is adjusted proportionally so that the overall amount of material such as material from the mixer of material pumped back into the extruder remains constant or equal to the amount of initial material used as a raw material.

The control system may comprise a flow meter, wherein the flow meter measures the amount of both the material fed into the extruder through the feeding side and the output material, HME material or reprocessed HME material from the extruder after the HME process. If the HME material via reprocessing (214) is added to the extruder, the dough or material through the feeding system (204) will be adjusted such that the total output from the extruder remains constant. Thus, the process of making plant-based food products comprises a backflow process aiding in reducing waste by reprocessing the dough, comprising finely cutting and kneading the dough, and feeding the dough into the extruder for another round of HME process.

The control system (215) is further connected to a production line main system or production line central system, wherein the control system continually communicates with the main system during an active production phase, conveying to the main system amount of material to be adjusted via the feeding system for keeping the total throughput from the extruder constant or a defined amount. For example, if the weight of the raw material or initial material is 500 kg and the reprocessed material after undergoing the rework process is 50 kg. The amount of raw material will be reduced proportionally so that the total output from the extruder remains constant or a defined amount matching with the amount of initial material.

If, after passing through the control system, the HME material from the HME extrusion process is of an acceptable standard, the HME material moves further to a next step in food production, such as cutting (206) in chunks of any shape or size. The chunks are then mixed with at least an additional ingredient (207) within a cooking tumbler (208), wherein the ingredient may include but is not limited to spices, spice extracts, salt, vegetable oil, flavors, etc. The choice of ingredients depends on the flavor, recipe, and type of food produced or user's preference. Once the ingredients (207) are mixed with chunks from the HME process in a cooking tumbler (208), the mixture may be subjected to heating (209) within the cooking tumbler or the chunks are directly introduced to freezing for packaging and preservation, thus not subjecting the chunks to heating. If the chunks are subjected to heating, the chunks or material may be heated at a temperature of at least 80° C. or more than 80° C.

Owing to the batch mixing process described in FIG. 2, the material/dough or food does not undergo a typical sudden pressure loss related expansion as the temperature of the cooling die is far below 100° C. Whereas aerated extruded products generally expand at the outlet of the extruder die because of this pressure loss in passing the die, having a temperature T>100° C. (e.g. TVP, breakfast cereals, snacks). Therefore, the presently disclosed process provides advantage over the known methods.

Following heating, the material such as HME material or reprocessed HME Material as chunks or otherwise is subjected to IQF-freezing (210), wherein the chunks or material is frozen and prepared further for preservation, transport, and sale. Following heating and freezing, the end food product or chunks is packaged in packaging trays with sleeves (211). The final packaging maybe carried in the presence of protective gas with at least 160 g of food product packaged per tray (211), followed in some cases by freezing (216). The quantity of the food product packaged depends on a number of factors, including but not limited to the density of the food product, size of the packaging tray, and size of the sleeves, among others.

Depending on these various factors, more or less than 180 g of the food product may be packaged per packaging tray (or another packaging). Further, other types of packaging may also be employed such as QSR (box with in-liner) or retail cardboard box for retail frozen. Both the QSR packaging and retail cardboard packaging can be done without the use of protective gas.

The packaged tray may be assigned a batch number or an identification number printed on the tray, sleeve, or other visible location. The packaging tray will also comprise metal detection or other such embodiments necessary and regularly employed as part of the food manufacturing, packaging, and transport process, such as before the food product is sent to the customer, BBD is printed.

A powerful mono pump may also replace a sausage filler, wherein the reprocessed material or HME material may be pumped back into the extruder for another round of HME via the mono pump. As explained and shown in FIG. 2, the presently disclosed batch mixing process provides certain advantages over the standard process. The composition of the vegetable protein and water ratio defines the structure of the finished product. As disclosed, the protein and water may be mixed in a ratio of 1:1, 1:2 (one-part protein and two-parts water), 1:3 (one-part protein and three-parts water), 2:1 (two-parts protein and one-part water), 2:2 (two-parts protein and two-parts water), 3:1 (three-parts protein and one-part water), 1:4 (one-part protein and four-parts water), or another desired ratio resulting in a dry and crumbly dough with air in it. Further, the choice of protein also affects the finished food product. By way of example only and in no way limiting, the use of soy protein concentrate with a high fiber content may also affect the final texture and structure of the finished food product. Proteins with a high amount of fiber up to 20% may form a matrix structure that aids in immobilization of air from the dough or finished food product and thus provides a lighter color and structure to the finished food products similar to meat food products. However, a vegetable protein with low fiber content may also form plant-based food products using the batch mixing process, as disclosed in FIG. 2 of the present disclosure.

Batch mixing, as described in FIG. 2 forms a dry and crumbly dough with air trapped within. Once the dough is introduced into the HME extrusion process via sausage filler, the system or the extrusion system completely shuts or closes, and as a result, no air from the food or dough can escape from the dough to the feeding side. As a result, the air within the dough remains trapped, but due to the extrusion process, it is homogeneously distributed as fine air bubbles throughout the HME material. The homogeneous distribution of air bubbles could also make the final product slightly spongy or fluffy, whereas the fibry structure from the plant protein remains intact, thus providing a texture of aerated plant fiber but without any external gas. The homogeneous distribution of air bubbles resulting from the batch mixing process imparts a lighter color to the finished food product. The color of the food product is similar to the color of the meat food product, such as color of the cooked chicken. Further, the batch mixing process also provides a reduced density to the food product as compared to the density of the food product made by known standard processes.

In the description, for purposes of explanation and not limitation, specific details are set forth, such as particular embodiments, procedures, techniques, etc., to provide a thorough understanding of the present technology. However, it will be apparent to one skilled in the art that the present technology may be practiced in other embodiments that depart from these specific details.

While specific embodiments of, and examples for, the process and compositions are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways.

While various embodiments have been described above, it should be understood that they have been presented by way of example only, and not in limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A rework process of plant-based food production, comprising:
providing a batch of material, comprising at least a plant protein and at least an aqueous phase, introduced simultaneously, wherein the material blends within a mixer to form a dough;
feeding the dough into an extruder via a sausage filler;
subjecting the dough to an initial high moisture extrusion (HME) process within the extruder, wherein the dough undergoes HME process, pass through a cooling die, and is discharged from the extruder as HME material; and
passing the HME material through a control system, wherein the control system assesses the quality of the HME material against a pre-defined parameter within the control system, such that if the HME material is as per the pre-defined parameter, the HME material is subjected to further processing to make a food product, or the HME material is subjected to reprocessing, wherein the HME material is pumped back into the extruder using via the pressure generated by sausage filler and subjected to another round of HME process, and wherein the reprocessing improves food productivity by reducing waste production during plant-based food production.

2. The rework process of claim 1, wherein the reprocessing comprises:
finely cutting the HME material as tiny chunks;
kneading the finely cut HME material;
pumping the HME material via the sausage filler back into the extruder, wherein the HME material is subjected to another round of HME process forming a reprocessed HME material; and
subjecting the reprocessed HME material to further processing to make a food product, wherein the reprocessing improves food productivity by reducing waste production during plant-based food production.

3. The rework process of claim 2, wherein further processing to make a food product, comprises:
cutting the reprocessed HME material in chunks of any shape or size;
heating the chunks at a temperature of at least 80° C.;
freezing the chunks for preservation and transportation; wherein the chunks as a packaged material may be a component for producing a plant-based food product or used directly as a plant-based food product.

4. The rework process of claim 1, wherein the control system manages the total output from the extruder, such that if the HME material after reprocessing is pumped back into the extruder for another round of HME, the dough from the mixer is adjusted proportionally so that the amount of the material entering into the extruder is equal to the amount of batch of material provided at the initiation of plant-based food production.

5. The rework process of claim 1, wherein the control system reduces waste formation during plant-based food production.

6. The rework process of claim 1, wherein the control system comprises a flow meter, wherein the flow meter measures the amount of dough from the extruder, such that if the dough from the extruder reaches a certain pre-set limit, a message is communicated to a main system of the food production system to proportionally adjust the next batch of material to maintain the total output of the food produced per production line as constant.

7. The rework process of claim 6, wherein the control system communicates with the main system throughout active food production.

8. The rework process of claim 2, wherein the reprocessing further comprises: optionally mixing the HME material with water or plant protein before pumping the output material into the extruder.

9. The rework process of claim 1, wherein the control system assesses the quality of the dough in an early stage of food production and improve food production.

10. A process of reprocessing raw material for making food in early stages of food production, comprising:
providing a batch of material, comprising at least a plant protein and at least an aqueous phase, introduced simultaneously, wherein the material blends to form a dough;
feeding the dough into an extruder via a sausage filler;
subjecting the dough to an initial high moisture extrusion (HME) process within the extruder, wherein the dough undergoes HME process, pass through a cooling die, and is discharged from the extruder as HME material; and
passing the HME material through a control system, wherein the control system assesses the quality of the HME material against a pre-defined parameter within the control system, such that if the HME material is as per the pre-defined parameter, the HME material is subjected to further processing to make a food product, comprising
cutting the reprocessed HME material in chunks of any shape or size;
heating the chunks at a temperature of at least 80° C.;
freezing the chunks for preservation and transportation; wherein the chunks as a packaged material may be a component for producing a plant-based food product or used directly as a plant-based food product;
or
the HME material is subjected to reprocessing, wherein the HME material is pumped back into the extruder using via the pressure generated by sausage filler and subjected to another round of HME process, comprising
finely cutting the HME material as tiny chunks;
kneading the finely cut HME material;
pumping the HME material through sausage filler into the extruder, wherein the HME material is subjected to another round of HME process making reprocessed HME material; and
subjecting the reprocessed HME material to further processing to make a food product, wherein the reprocessing improves food productivity by reducing waste production during plant-based food production.

11. The rework process of claim 10, wherein the control system manages the total output from the extruder, such that if HME material after reprocessing is pumped back into the extruder for another round of HME, the dough from the mixer is adjusted proportionally so that the amount of material entering into the extruder is equal to the amount of batch of the material provided at the initiation of plant-based food production.

12. The rework process of claim 10, wherein the control system maintains the total output of food produced per production line as constant.

13. The rework process of claim 10, wherein the control system comprises a flow meter, wherein the flow meter measures the amount of dough from the extruder, such that if the dough from the extruder reaches a certain pre-set limit, a message is communicated to a main system of the food production system to proportionally adjust the next batch of material to maintain the total output of the food produced per production line as constant.

14. The rework process of claim 13, wherein the control system communicates with the main system throughout active food production.

15. The rework process of claim 10, wherein the reprocessing further comprises: optionally mixing the HME material with water or plant protein before pumping the HME material into the extruder.

16. The rework process of claim 10, wherein a pressure generated by sausage filler pumps the batch of material or HME material into the extruder for HME processing.

17. The rework process of claim 10, wherein the process improves food quality as the control system assesses the quality of the HME material in an early stage of food production.

18. A process of reprocessing raw material for making plant-based food product into an extruder during plant-based food production, comprising:
providing a batch of material, comprising at least a plant protein and water, introduced simultaneously, wherein the material blends to form a dough;
feeding the dough into an extruder via a sausage filler;
subjecting the dough to an initial high moisture extrusion (HME) process within the extruder, wherein the dough undergoes HME process, pass through a cooling die, and is discharged from the extruder as HME material; and
passing the HME material through a control system, wherein the control system assesses the quality of the HME material against a pre-defined parameter within the control system, such that if the HME material is as per the pre-defined parameter, the HME material is subjected to further processing to make a food product, or the HME material is subjected to reprocessing, wherein the HME material is pumped back into the extruder using the pressure generated by the use of sausage filler and subjected to another round of HME process, and wherein the reprocessing improves food productivity by reducing waste production during plant-based food production.

19. The process of claim 18, wherein the reprocessing comprises:
finely cutting the HME material as tiny chunks;
kneading the finely cut HME material;
pumping the HME material through sausage filler into the extruder, wherein the HME material is subjected to another round of HME process making reprocessed HME material; and
subjecting the reprocessed HME material to further processing to make a food product, wherein the reprocessing improves food productivity by reducing waste production during plant-based food production.

20. The process of claim 18, wherein the control system maintains the total output of food produced per production line as constant.
